(19) United States
(12) Patent Application Publication
(10) Pub. No.: US 2018/0294485 A1
(43) Pub. Date: Oct. 11, 2018

(54) OXYGEN REDUCTION REACTION CATALYST

(71) Applicants: JOHNSON MATTHEY FUEL CELLS LIMITED, London (GB); CENTRE NATIONAL DE LA RECHERCHE SCIENTIFIQUE, Paris (FR); UNIVERSITE MONTPELLIER, Montpellier (FR)

(72) Inventors: Marie Josephe Vanessa ARMEL, Montpellier (FR); Stephen Charles BENNETT, Reading (GB); Frederic Christophe JAQUEN, Montpellier (FR); Deborah JONES, Montpellier (FR); Sheena HINDOCHA, Reading (GB); Fabrice SALLES, Montpellier (FR)

(21) Appl. No.: 15/757,171

(22) PCT Filed: Sep. 8, 2016
(86) PCT No.: PCT/GB2016/052774

§ 371 Date: Mar. 2, 2018

(30) Foreign Application Priority Data
Sep. 8, 2015 (GB) 1515869.4

(51) Int. Cl. H01M 4/90; H01M 4/86; H01M 4/88

(52) U.S. Cl. CPC H01M 4/90; H01M 2004/8689; H01M 4/8828; H01M 4/8668

(57) ABSTRACT

A method for the manufacture of an oxygen reduction reaction (ORR) catalyst, the method comprising; providing a metal organic framework (MOF) material having a specific internal pore volume of 0.7 cm³g⁻¹ or greater; providing a source of iron and/or cobalt; pyrolysing the MOF material together with the source of iron and/or cobalt to form the catalyst, wherein the MOF material comprises nitrogen and/or the MOF material is pyrolysed together with a source of nitrogen and the source of iron and/or cobalt is disclosed.

### FIELD OF THE INVENTION

The present invention relates to a process for the manufacture of an oxygen reduction reaction (ORR) catalyst, and in particular to the manufacture of a cathode electrode comprising the catalyst for use in a fuel cell for the ORR. The invention provides an ORR catalyst with a high activity.

### BACKGROUND OF THE INVENTION

A fuel cell is an electrochemical cell comprising two electrodes separated by an electrolyte. A fuel, such as hydrogen or an alcohol, such as methanol or ethanol, is supplied to the anode and an oxidant, such as oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

In a hydrogen-fuelled or alcohol-fuelled proton exchange membrane fuel cell (PEMFC), the electrolyte is a solid polymeric membrane, which is electronically insulating and proton conducting. Protons, produced at the anode, are transported across the membrane to the cathode, where they combine with oxygen to form water. The most widely used alcohol fuel is methanol, and this variant of the PEMFC is often referred to as a direct methanol fuel cell (DMFC).

It is well known to use platinum nanoparticles as the electrocatalyst in the electrodes of such fuel cells. However, platinum is an expensive material and it is desirable to find alternative materials for splitting the oxygen (O₂) molecules in the cathode electrode of the fuel cell.

It is known to use Metal-N—C catalysts as an alternative to platinum. An active Fe—N—C catalyst is known which has been produced after the pyrolysis of catalyst precursors comprising an iron precursor and a metal organic framework (MOF) material, known as ZIF-8, where ZIF is a zeolitic imidazolate framework. However, the volumetric activity of the Fe—N—C catalyst is lower than that of platinum-based catalysts. To overcome this issue, thicker cathode layers, typically 60-100 μm, for the PEM fuel cell are presently fabricated for use of these non-platinum catalysts. However, this leads to severe mass-transport limitations (arising from oxygen diffusion, water removal, electron and proton conduction issues across the thick cathode layer). Overall, the power density performance obtained with state-of-the-art Metal-N—C cathodes does not reach that obtained with Pt-based catalysts, especially when operating under practical conditions and using air as the cathode reactant.

Hence, novel Metal-N—C catalysts with higher volumetric activity than the state-of-the-art are necessary in order to be able to reduce the thickness of Metal-N—C based cathodes while maintaining sufficient activity for the ORR.

Ma et al (Cobalt imidazolate framework as precursor for oxygen reduction reaction electrocatalysts; Chemistry a European Journal; 2011; 17; 2063-2067) were the first to disclose the preparation of an ORR catalyst from a MOF precursor. This document teaches the pyrolysis of Co-ZIFs to yield the electrocatalyst. The authors consider the pyrolysis (thermal activation) temperature and its effect on catalytic activity. Based on structural data they proposed an active site structure. They also identified issues with the use of Co-ZIFs; one of them being the agglomeration of cobalt that needs to be removed to increase the catalyst activity to weight ratio. However, encapsulation of metallic cobalt by carbon shells prevents the complete removal of inactive cobalt, and the high amount of cobalt in Co-ZIFs results in highly graphitic materials with a low number of active sites, and hence a moderate activity.

Zhao et al (Highly efficient non-precious metal electrocatalysts prepared from one-pot synthesized zeolitic imidazolate frameworks; Advanced Materials; 2014; 26; 1093-1097) disclose the synthesis of ZIFs as catalyst precursors that can be activated by pyrolysis. The authors investigated the effect of the specific imidazole ligands (imidazole, methyl imidazole, ethyl imidazole and the like) on the catalytic activity, identifying Zn(eIm)₂. qtz as yielding the best catalyst in this study. No correlation between the structure or chemistry of the starting ZIFs and the ORR activity of the pyrolyzed materials was observed or discussed in this work.

Xia et al (Well-defined carbon polyhedrons prepared from nano metal-organic frameworks for oxygen reduction; Journal of Materials Chemistry A; 2014; 2; 11606) investigated the effect of ZIF crystal size on catalytic activity. They obtained monodisperse ZIF-67 (Co(II) ligated with 2-methylimidazole) crystals of controllable size via altering the solvent and temperature of reaction. The authors found that catalyst activity increased with decreasing crystal size. The crystals investigated ranged from 300 nm to several micrometres. The ORR activity of the pyrolyzed materials was moderate, due to the use of a Co-based ZIF, with a cobalt content higher than is optimal for Co—N—C catalyst precursors. The limitations of this approach are the same as those described above in the initial approach by Ma et al (Chemistry a European Journal; 2011; 17; 2063-2067).

Jaouen et al (Heat-Treated Fe/N/C Catalysts for O₂ Electroreduction: Are Active Sites Hosted in Micropores?; Journal of Physical Chemistry B 2006; 110; 5553-5558) disclose synthesis of electrocatalysts from carbon black by heat treatment with iron acetate and ammonia. The authors investigated the catalyst pore sizes and found that the micropore area (surface area of pores of width<22 Å) was the limiting factor in catalytic activity. This document teaches that ammonia etching of carbon black produces micropores for active site formation, but does not mention MOFs. This synthesis approach resulted in catalysts with moderate ORR activity. It is believed that this may be due to the absence of micropores in the catalyst precursor, and the location of the iron salt outside micropores, before pyrolysis.

Therefore, one aim of the present invention is to provide an improved process that tackles the drawbacks associated with the prior art, or at least provides a commercial alternative thereto.

### SUMMARY OF THE INVENTION

According to a first aspect, the invention provides a method for the manufacture of an oxygen reduction reaction (ORR) catalyst, the method comprising;
providing a metal organic framework (MOF) material having a specific internal pore volume of 0.7 cm³g⁻¹ or greater;
providing a source of iron and/or cobalt;
pyrolysing the MOF material together with the source of iron and/or cobalt to form the catalyst,
wherein the MOF material comprises nitrogen and/or the MOF material is pyrolysed together with a source of nitrogen and the source of iron and/or cobalt.

According to a second aspect, the invention provides a method for the manufacture of an oxygen reduction reaction (ORR) catalyst, the method comprising:
providing a metal organic framework (MOF) material having an isotropic cavity shape with a largest cavity size of 12 Å or greater;
providing a source of iron and/or cobalt;
pyrolysing the MOF material together with the source of iron and/or cobalt to form the catalyst,
wherein the MOF material comprises nitrogen and/or the MOF material is pyrolysed together with a source of nitrogen and the source of iron and/or carbon.

According to a third aspect, the invention provides a method for the manufacture of an oxygen reduction reaction (ORR) catalyst, the method comprising:
providing a metal organic framework (MOF) ligand and MOF metal source;
providing a source of iron and/or cobalt;
optionally providing a source of nitrogen;
providing a source of energy sufficient to provide a catalyst precursor comprising a MOF material having a specific internal pore volume of 0.7 cm³g⁻¹ or greater;
and pyrolysing the catalyst precursor to provide the ORR catalyst.

According to a fourth aspect, the invention provides a method for the manufacture of an oxygen reduction reaction (ORR) catalyst, the method comprising:
providing a metal organic framework (MOF) ligand and MOF metal source;
providing a source of iron and/or cobalt;
optionally providing a source of nitrogen;
providing a source of energy sufficient to provide a catalyst precursor comprising a MOF material having an isotropic cavity shape with a largest cavity size of 12 Å or greater,
and pyrolysing the catalyst precursor to provide the ORR catalyst.

The present disclosure will now be described further. In the following passages different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

### DETAILED DESCRIPTION OF THE INVENTION

The invention relates to the manufacture of an oxygen reduction reaction catalyst. That is, a catalyst which when present in a fuel cell can be used to catalyse oxygen reduction. The oxygen reduction activity of a material can be readily measured and compared in a laboratory-scale proton exchange membrane fuel cell.

The present invention provides ORR catalysts with a high activity. Advantageously, the catalysts are based on Earth-abundant transition metal elements (iron and/or cobalt), nitrogen, and carbon and can serve to catalyse dioxygen electro-reduction to water in various electrochemical energy conversion devices.

The present inventors have found that they can determine the dioxygen electro-reduction activity of an ORR catalyst based on the material used to form it. In particular, they have determined that when deriving a Metal-N—C catalysts (Metal=Fe or Co) from a metal organic framework material by pyrolysis, the activity of the product can be predicted from certain characteristics of the starting material. Indeed, the predictive character of this structure/property relationship has permitted the selection of MOF materials that result in Metal-N—C catalysts with a higher electrocatalytic activity for O₂ reduction than has been reported previously.

As will be appreciated, MOF materials are well known in the art, including those having a specific internal pore volume>0.7 cm³/g and/or having a cavity size>12 Å. Cavity size measurement and specific internal pore volumes are discussed in more detail below. However, none of these have hitherto been investigated as a sacrificial precursor for the production of Metal-N—C (where Metal=iron or cobalt) catalysts. Moreover, the role of the specific internal pore volume and/or cavity size of pristine MOFs in setting the ORR activity of Fe/Co—N—C materials obtained after pyrolysis has never been realised.

The method comprises providing a metal organic framework material. Metal-organic frameworks are a class of materials comprising metal ions or clusters linked by organic ligands to form one-, two-, or three-dimensional structures. Recently MOFs have been the focus of intense research since they have the potential to be designed via the selection of the organic and inorganic components to have high surface areas and predictable, well defined porous structures. Accordingly, there is much interest in investigating their use in a range of applications including in gas storage, gas separation, catalyst synthesis, sensing etc.

The key component of this invention is the use of MOFs with a specific structure (cavity size, or specific internal pore volume) to prepare a catalyst precursor which is subsequently pyrolysed to provide the ORR catalyst. The preparation of a catalyst precursor comprising such MOFs and an iron or cobalt precursor (typically, a salt) can be performed in various ways.

In one method for forming the catalyst precursor, the MOF is formed first and then combined with the iron or cobalt source to form the catalyst precursor. A nitrogen source is also required if the MOF ligand does not comprise nitrogen and is optional even if the MOF ligand does comprise nitrogen.

In an alternative method, the catalyst precursor is formed as part of the MOF synthesis (so-called one-pot synthesis). In this method, the MOF ligand and MOF metal source are combined with a source of Co and/or Fe and optionally a source of nitrogen (a source of nitrogen is required if the MOF ligand does not comprise nitrogen). An energy source is provided (e.g. grinding, ball milling, solvothermal energy etc) to form the catalyst precursor comprising a MOF and the source of Co and/or Fe and optionally a source of nitrogen. The MOF ligand is one of those mentioned hereinafter and the MOF metal source is suitably an oxide of one of the transition metals mentioned hereinafter. The particular MOF material formed can be identified by comparison of its X-ray diffraction (XRD) pattern with the XRD pattern of a known MOF and subsequently enables determination of the internal pore volume using the method hereinafter described.

Preferably the MOF material comprises a transition metal selected from Zn, Mg, Cu, Ag, and Ni, or a combination of two or more thereof. The use of Mg and/or Zn, and in particular Zn, is preferred since these metals, which have low boiling points, are almost entirely removed during pyrolysis, while trace amounts left in the processed materials may be easily removed after pyrolysis.

Preferably the MOF material is a zeolitic imidazolate framework (ZIF) material with a high specific internal pore volume and a large cavity size. This class of MOFs comprise tetrahedrally coordinated transition metal ions connected by organic imidazole or imidazole derivative linkers. Their name is derived from the zeolite-like topologies they adopt, which is due to the metal-imidazole-metal angle being similar to the Si—O—Si angle in zeolites.

For MOF crystalline materials and ZIF materials as a sub-class of MOFs, the identification of a given material must comprise the nature of the metal cation, the ligand(s), and the structure in which the metal cation and the ligand(s) crystallized. For the ZIF sub-class of MOFs, the structure is also identified with the three letters of the net structure, zni, qtz, dia, etc (for a list of the net structures and their exact meaning, see Reticular Chemistry Structure Resource, http://rcsr.anu.edu.au). To further exemplify that solely reporting the nature of the metal cation, nature of the ligand, and the cation:ligand stoichiometry of a MOF is insufficient to identify a unique MOF, one may simply recognize the fact that at least three different ZIF materials exist for a same metal cation (Zn(II)) and a same ligand (2-ethylimidazole, eIm) with 1:2 stoichiometry: Zn(eIm)₂ in qtz crystalline topology (cavity size 1.5 Å, pore volume 0.17 cm³g⁻¹), Zn(eIm)₂ in ana crystalline topology (cavity size 5.0 Å, pore volume 0.49 cm³g⁻¹) and Zn(eIm)₂ in rho crystalline topology (cavity size 18.0 Å, pore volume 1.05 cm³g⁻¹).

Proietti et al, Nature Commun. 2 (2011) 443, discloses the use of ZIF-8 to produce an ORR catalyst. ZIF-8 has a cavity size of 11.6 Å, pore volume 0.66 cm³g⁻¹. The use of three other Zn-based ZIF materials as sacrificial precursors was investigated by Liu's group from Argonne National Laboratory (Advanced Materials 26 (2014) 1093). While the exact crystalline structures of those three ZIF materials are not explicitly reported in that work, the combined information on the three different ligands used with the reported XRD patterns for the three ZIF materials allows one to precisely identify the crystalline structures of those materials: they are Zn(Im)₂ in zni crystalline topology (cavity size 3.16 Å, pore volume 0.27 cm³g⁻¹), Zn(eIm)₂ in qtz crystalline topology (cavity size 1.5 Å, pore volume 0.17 cm³g⁻¹) and Zn(abIm)₂ in dia crystalline topology (cavity size 4.2 Å) (Im=Imidazolate, eIm=ethyl-imidazolate, abIm=aza-benzimidazolate). None of these three ZIF materials comprises a large cavity size nor results in high specific internal pore volume as discussed herein.

Preferably the ZIF is the rho structure of Zn(II) and 2-ethyl-imidazolate, a porous ZIF with large cavity size of 18.0 Å calculated with our methodology (21.6 Å has also reported by others) and a high specific internal pore volume of 1.05 cm³g⁻¹. This has been found to lead to a desirable ORR catalyst product.

The MOF may alternatively be MOF-5. MOF-5 is based on a benzenedicarboxylate ligand and has a known structure characterized by a largest cavity size of 15.0-15.2 Å and a specific internal pore volume of 1.32 cm³g⁻¹. MOF-5 is a well-known MOF which is not a ZIF material and is nitrogen-free. It has been found to lead to a desirable ORR catalyst product.

In one embodiment, the MOF may comprise two ligands, for example a benzenedicarboxylate ligand and a 1,4-diazabicycle[2.2.2]octane.

In order to provide a high activity catalyst material, the inventors have found that it is necessary to prepare catalyst precursors comprising MOF materials having a high specific internal pore volume (cm³g⁻¹). In particular, the use of MOF materials with a specific internal pore volume larger than 0.7 cm³g⁻¹ provides an improved ORR activity. Preferably the MOF material has a specific internal pore volume of 0.9 cm³g⁻¹ or greater, more preferably 1.1 cm³g⁻¹ or greater and even more preferably 1.3 cm³g⁻¹ or greater.

The large specific internal pore volume present in the MOFs before pyrolysis has been found to result in a higher catalytic activity of the final Fe—N—C catalysts formed after the pyrolysis step. This higher activity per mass of catalyst is due to either a modified carbonization process of MOFs during pyrolysis or due to the preferential formation of FeNxCy sites during pyrolysis, rather than the parallel formation of Fe/Co based crystalline structures inactive for ORR in acid electrolyte. This is surprising because the process for forming the Metal-N—C catalyst involves a profound structural change relative to the starting MOF. The good dispersion of Fe or Co ions in the catalyst precursors comprising MOFs with large specific internal pore volume may minimize the agglomeration of Fe or Co during pyrolysis, and maximize the formation of MetalNxCy (Metal=Fe or Co or a combination of both) active sites.

Preferably the synthesis targets MOF structures having large specific internal pore volume, but with a small crystal size (typically, 200 nm and less). This results in catalytic particles of reduced dimension and with improved access of oxygen to the active sites after pyrolysis.

Preferably the MOF material has an average crystal size with a longest diameter of 200 nm or less.

The method further comprises providing a source of iron and/or cobalt.

Preferably the source of iron and/or cobalt is a salt of iron and/or cobalt. Preferably the source is Fe(II) acetate or Co(II) acetate. Other salts, such as chloride, nitrate, oxalate and sulfate salts of Co(II), Fe(II) or Fe(III) may also be employed.

The method involves pyrolysing the catalyst precursor (MOF material together with the source of iron and/or cobalt) to form the catalyst. As discussed further below, the MOF material comprises nitrogen and/or the MOF material is also pyrolysed together with a separate source of nitrogen. This ensures the presence of all the raw ingredients required to arrive at the final Metal-N—C catalyst. Pyrolysis is the heating of a material in the absence of (atmospheric) oxygen.

This pyrolysis of the catalyst precursor is the critical stage for the synthesis of Metal-N—C catalyst (transformation of the MOF structure into a highly porous carbon structure with a large number of MetalNxCy sites, Metal=Fe or Co). The pyrolysis conditions (duration, temperature, mode of heating, gas used during pyrolysis) can readily be optimized for each novel MOF structure by experimental trial and error which is within the ability of the skilled person.

After optimization of such pyrolysis parameters correlation has also been found between the ORR activity of pyrolyzed Fe/Co—N—C materials and the specific internal pore volume of MOFs. This correlation is more universal than using cavity size since some MOF structures have very anisotropic cavity shapes.

All scientific reports or patents related to the use of MOF materials for fabricating Metal-N—C catalysts via pyrolytic steps are based on a trial-and-error approach for determining which MOF works well, and which does not. Using the method disclosed herein we can provide a rational selection of the most promising MOF structures. This approach has already resulted in the synthesis of several Fe—N—C catalysts with ORR activity significantly superior to that of the prior state-of-the-art. The concept has been demonstrated in particular for three distinct subclasses of MOFs: (i) ZIFs, ii) a cage structure (for example, of formulation [Zn₂(bdc)₂(dabco)] where bdc=1,4-benzenedicarboxylate and dabco=1,4-diazabicyclo[2.2.2]octane) (sample code CAT-19), and iii) a nitrogen-free MOF based on Zn(II) and carboxylate ligands (for example MOF-5).

Preferably the pyrolysis of the MOF material is conducted at a temperature of from 700 to 1500° C., preferably from 800 to 1200° C.; 900 to 1100° C. is preferred and is particularly appropriate for the Zn-based ZIFs. The pyrolysis of the MOF material is typically conducted for 1 to 60 minutes, preferably 5 to 30 minutes and most preferably 10 to 20 minutes, such as about 15 minutes.

The pyrolysis is preferably conducted under an atmosphere comprising an inert gas, such as argon or dinitrogen, or in the presence of a gas reacting with carbon such as ammonia, hydrogen, or mixtures thereof.

In order to form the desired catalyst, it is necessary for there to be a source of nitrogen in the pyrolysis step. Preferably the MOF material comprises nitrogen atoms from its constituent ligand(s). Imidazole ligands are preferred constituent ligands, resulting in the subclass of ZIF materials. The families of triazole or bipyridine ligands are other possible constituent ligands for MOF structures containing nitrogen atoms.

Regardless whether the MOF material comprises nitrogen or not, the presence of a secondary N-containing ligand (not a constituent of the MOF structure) is a preferred embodiment of the invention. A preferred secondary ligand is 1,10-phenanthroline, but other N-containing ligands could be used, and include bipyridine, ethylamine, tripyridyl-triazine, pyrazine, imidazole, purine, pyrimidine, pyrazole or derivatives thereof. This is not an exhaustive list.

The provision of a source of nitrogen allows for it to be included in the final product, but also can act as a ligand for iron or cobalt ions to prevent agglomeration of iron or cobalt ions during the catalyst precursor preparation. The use of a secondary N-rich ligand with strong affinity for Fe or Co ions moreover realizes Fe—N or Co—N bonds before pyrolysis, which favours the formation during pyrolysis of Metal-Nₓ—C_{y} moieties that are active towards the ORR.

Preferably the pyrolysis is conducted in two steps, a first step under an inert atmosphere and a second step under an atmosphere comprising ammonia, hydrogen, carbon dioxide and/or carbon monoxide. The second step acts like a further etching step to remove unwanted metal from the MOF and to improve the pore network of the formed carbonaceous material, in particular the micropore network (pore size of 5-20 Å). The first step and second step may be carried out at a similar or the same temperature; alternatively, the first step is carried out at a temperature higher than the second step.

Before pyrolysis, the MOF material and the source of iron and/or cobalt, and the optional additional source of nitrogen, are preferably mixed. Adequate mixing of the Fe or Co salt and the MOF is an important step in the synthesis. Suitable methods are known to people skilled in the art. The key at this stage is to avoid agglomeration of iron and/or cobalt atoms into aggregates, which would then lead to the formation of iron and/or cobalt-based crystalline structures during pyrolysis, instead of the formation of single metal atom Metal-NxCy sites (Metal is Fe or Co). The fine dispersion of Fe or Co atoms around the MOF crystals or in the MOF structures can be obtained by mechanical mixing (milling at low energy of MOF and metal salt, etc) or could be obtained by mixing a solution of the Fe or Co salts with the MOF and drying the resulting mixture prior to pyrolysis. Alternatively, fine dispersions of the Fe or Co could be obtained by sputtering low amounts of Fe or Co onto MOF powders (typically 1-2 wt % of Fe or Co in the catalyst precursor).

Preferably the mixing process is milling and preferably comprises a ball milling process. Ball milling process is preferably conducted at a speed of from 50 to 600 rpm, preferably less than 200 rpm. Preferably the balls are zirconium oxide and have a diameter of about 5 mm. Alternatively, the mixing process can be performed in a high speed mixing process in the absence of any milling media (using for example a Speedimixer equipment). In such a piece of equipment the crystals of material are subject to attrition against each other leading to an intimate mixture.

Optionally, the method further comprises an acid washing step after the step of pyrolysing the MOF material. Zinc and Mg containing MOFs do not require an acid wash, though this can still be helpful to ensure the metal is fully removed. The acid wash may involve the use of HCl, H₂SO₄, HNO₃ or HF. The acid washing (or etching) step serves to improve the pore network of the formed carbonaceous material, in particular the micropore network (pore size of 5-20 Å).

It is also desirable for the MOF material to have a large cavity size, in particular, larger than 12 Å. For MOF structures showing several cavity sizes in the same structure, the present patent application concerns such MOFs whose largest cavity size is greater than 12.0 Å. Preferably the MOF material has a largest cavity size of 12 Å or greater, and preferably a largest cavity size of 15 Å or greater and more preferably a largest cavity size of 18 Å or greater. However, it is only possible to obtain a meaningful calculation for the cavity size for MOFs in which only one shape of cavity is present and if that shape of cavity is isotropic, i.e. the dimensions of the cavity are generally equal in all directions, such as for example a spherical or cubic cavity. The cavity size can be determined by methods described hereinafter.

The MOF material may be provided on an electrically conducting support, preferably a carbon material (e.g. particulate carbon blacks, heat-treated or graphitised versions thereof, or nanotubes or nanofibers) or a doped metal oxide. The provision of the support material doesn't impact the nature/structure of the MOF material itself. Instead, it is there primarily to help introduce some appropriate macrostructural properties to the subsequent electrode structures that the catalyst is incorporated into. Preferably the targeted MOF structures are synthesised on selected electronically conducting supports such as carbon materials (particulate carbon blacks, heat-treated or graphitised versions thereof, nanofibers, nanotubes, etc.) or doped metal oxides. Addition of iron or cobalt ions to such a composite material results in a catalyst precursor which, after pyrolysis, has a controlled morphology of the catalyst at the microscopic level (pyrolyzed MOF) and macroscopic level (carbon fibres or tube network, with macroporosity)

According to one embodiment, the method further comprises forming an ink composition comprising the catalyst and a dispersion of a proton-conducting polymer in a suitable solvent, such as water, or a mixture of water and organic solvents such as alcohols.

According to a further aspect there is provided an ink comprising the ORR catalyst described herein, together with a proton-conducting polymer. This ink is suitable for use in preparing a cathode catalyst layer. Preferably the polymer comprises Nafion™ (available from Chemours Company) or any other sulfonated polymer with high proton conductivity (e.g. Aquivion® (Solvay Specialty Polymers), Flemion™ (Asahi Glass Group) and Aciplex™ (Asahi Kasei Chemicals Corp).

According to a further aspect there is provided an ORR catalyst obtainable by the method described herein.

According to a further aspect there is provided a cathode electrode for a fuel cell comprising the ORR catalyst described herein. Preferably the electrode is for use in a proton exchange membrane fuel cell, although other types of fuel cell can be contemplated including phosphoric acid fuel cells, or alkaline fuel cells, or the oxygen electrode of a regenerative fuel cell. It could also be employed in any other electrochemical devices where one of the electrodes is required to perform the oxygen reduction reaction, such as in metal-air batteries.

Advantageously, because of the activity of the catalyst, the catalyst can be provided as a cathode layer in a membrane electrode assembly (MEA), the cathode layer having a mean thickness of less than 60 microns. This permits good efficacy while avoiding the disadvantages of the prior art as discussed above. In particular, the catalyst can be incorporated as a layer applied to a membrane to form a catalyst coated membrane (CCM) or as a layer on a gas diffusion layer (GDL) to form a gas diffusion electrode (GDE), and then into the MEA of a PEMFC.

According to a further aspect there is provided a proton exchange membrane fuel cell comprising the cathode electrode described herein.

### BRIEF DESCRIPTION OF THE DRAWINGS

FIGS. 1 to 6 show non-limiting figures according to the present invention.

FIG. 1 shows the PEM fuel cell polarization curves recorded for MEAs comprising different catalysts at the cathode, in the high potential region where the fuel cell performance is controlled by the cathode ORR kinetics.

FIG. 2 shows ORR activity of Fe—N—C catalysts after pyrolysis at optimum temperature for each MOF against the specific internal pore volume of the pristine MOFs.

FIG. 3 shows ORR activity of Fe—N—C catalysts against the isotropic cavity size in the pristine MOFs. For each pristine MOF, three pyrolysis temperatures were investigated.

FIG. 4 shows ORR activity of Fe—N—C catalysts after pyrolysis at optimum temperature for each MOF against the isotropic cavity size in the pristine MOFs.

FIG. 5 shows ORR activity of Fe—N—C catalysts after milling at 100 rpm against the specific internal pore volume of the pristine ZIF-based MOFs.

FIG. 6 shows ORR activity of Fe—N—C catalysts prepared using the ‘one-pot’ synthesis method.

### EXAMPLES

The invention will now be described in relation to the following non-limiting examples.

### Measurement Techniques

### Specific Internal Pore Volume

The specific internal pore volume was calculated using crystallographic structures for each MOF. For that purpose, the crystal structure was first built following the single crystal data given in the literature for each solid. The geometry was optimised using Lennard Jones parameters and electrical charges to determine the positions of the atoms in the structure. In this case, the Universal Force Field (UFF) for Lennard Jones parameters was considered. Within the entire volume of optimized structures and following the strategy previously reported by Düren et al. (T. Düren, F. Millange, G. Férey, K. S. Walton, R. Q. Snurr, J. Phys. Chem. C, 2007, 111, 15350), a theoretical probe size of 0 Å was then used to determine the entire volume of the unit crystallographic cell. The unit cell is the smallest volume of a crystalline solid determined by its repetition in three dimensions that can predict the macroscopic structure of the solid. The volume of the unit cell was determined by moving the 0 Å theoretical probe inside the entire unit cell. This determined whether the probe was localized in the space occupied by atoms or in the free volume, i.e. in pores, using a Monte Carlo algorithm. Such a strategy allowed the determination of the specific internal pore volume of the macroscopic porous solid by dividing the free pore volume of the unit cell by the mass of the atoms present in the unit cell.

### Pore Size Distribution and Isotropic Cavity Size

Using the same parameters for the structure atoms (UFF), the methodology of Gelb and Gubbins (L. D. Gelb, K. E. Gubbins, Pore size distributions in porous glasses: a computer simulation study, Langmuir, 1999, 15, 305-308) was used to calculate the pore size distribution (PSD). It consists of trying to position spheres of increasing diameter into the free volume of the unit cell in order to determine the largest sphere able to fit in the structure, using Monte Carlo calculations. Evidently, the sphere occupies the free pore volume of the unit cell and cannot be superposed with the space occupied by atoms of the structure. Using this methodology, it is possible to determine the pore size distribution (PSD), i.e. the probability to find pores of a given size in the structure. Using the PSD curve, it is then possible to estimate the isotropic cavity size, as well as the size of the windows allowing species to pass from one cavity to another in the structure.

### Exemplary Synthesis Method 1

Catalyst precursors were prepared via a dry ball-milling approach from a given MOF powder, Fe(II) acetate and 1,10-phenanthroline.

Weighed amounts of the dry powders of Fe(II)Ac, phenanthroline and ZIF-8 were poured into a ZrO₂ crucible. 100 zirconium-oxide balls of 5 mm diameter were added and the crucible was sealed under air, and placed in a planetary ball-miller. Generally, the ball-to-catalyst precursor ratio and/or milling speed can be adjusted in order to keep the crystalline structure of the pristine MOF intact after the milling, as demonstrated by XRD patterns. With the milling conditions and equipment employed, the XRD of the MOFs were shown to be unmodified after the milling step when using a milling speed of 100 rpm.

The resulting catalyst precursor was then pyrolyzed at a given temperature (900° C. or more for zinc-based MOFs). The pyrolysis temperature was optimized for each MOF, by steps of e.g. 50° C. In this first method, the catalyst precursor was directly pyrolyzed in flowing NH₃ for 15 minutes via a flash pyrolysis mode (see Jaouen et al, J. Phys. Chem. B 110 (2006) 5553). All catalyst precursors contained 1 wt % of iron and the mass ratio of phenanthroline to ZIF-8 was 20/80. The obtained powder was finally ground in an agate mortar.

### Worked Examples—First Series

All catalysts in the first series of examples were prepared and tested in a similar manner, the sole difference being the nature and structure of the MOFs used to prepare the catalyst precursors.

The MOFs listed in Table 1 were synthesized beforehand according to previously reported methods, except for ZIF-8 which was purchased from Sigma Aldrich (trade name Basolite®, produced by BASF).

The catalyst precursors for the synthesis of Fe—N—C catalysts were prepared from fixed amounts of Fe(II)acetate (Fe(II)Ac), 1,10-phenanthroline (phen) and MOF. Catalysts were prepared through a dry ball milling approach. The dry powders of Fe(II)Ac, phen and a given MOF were weighed (31.4, 200 and 800 mg respectively) and poured into a ZrO₂ crucible filled with 100 zirconium oxide balls of diameter 5 mm. The crucible was sealed under air and placed in a planetary ball-miller to undergo ball-milling at 400 rpm. The resulting catalyst precursor was then transferred into a quartz boat and inserted into a quartz tube and shock-heated within about 2 minutes to the temperature of pyrolysis (900, 950 or 1000° C.) in a flowing NH₃ atmosphere and held at this temperature for 15 minutes. The pyrolysis was stopped by opening the split hinge oven and directly removing the quartz tube from the oven. The resulting catalyst was investigated as is. No acid wash was performed.

TABLE 1

| | | | | Specific internal | Isotropic |
|---|---|---|---|---|---|
| Sample | | | | pore volume, | Cavity size, |
| code | Formula/Name | Ligand | Topology | calculated/ cm³g⁻¹ | Calculated/Å |
| CAT-29 | [Zn(Im)(mIm)]- | Imidazole, | zni | 0.21 | 1.16 |
| | ZIF-61 | 2-methylimidazole | | | |
| CAT-37 | [Zn(eIm)₂] | 2-ethylimidazole | qtz | 0.17 | 1.5 |
| | qtz | | | | |
| CAT-30 | [Zn(Im)₂]/ | Imidazole | cag | 0.43 | 4.76 |
| | ZIF-4 | | | | |
| CAT-38 | [Zn(Im)₂]-zni | Imidazole | zni | 0.27 | 3.16 |
| CAT-14 | [Zn(bzIm)₂] | Benzimidazole | sod | 0.37 | 3.5 |
| | ZIF-7 | | | | |
| CAT-31 | [Zn(eIm)₂] | 2-ethylimidazole | ana | 0.49 | 5.0 |
| | ZIF-14 | | | | |
| ZIF 8 | [Zn(mIm)₂] | 2-methylimidazole | sod | 0.66 | 11.6 |
| | ZIF-8 | | | | |
| CAT-12 | [Zn(bzIm)₂] | Benzimidazole | rho | 0.56 | 13.8 |
| | ZIF-11 | | | | |
| CAT-28 | [Zn(eIm)2] | 2-ethylimidazole | rho | 1.05 | 18.0 |
| (inventive) | rho | | | | |
| CAT-19 | [Zn₂(bdc)₂(dabco)] | 1,4-benzenedicarboxylate, | — | 0.92 | Anisotropic |
| (inventive) | | 1,4-diazabicyclo[2.2.2]octane | | | cavity |
| MOF-5 | [Zn₄O(bdc)₃] | 1,4- | pcu | 1.32 | 12.0/15.2 |
| (inventive) | | benzenedicarboxyiate | | | |

Table 1 provides a summary of the imidazole-based MOFs and non-ZIF MOFs investigated. Im=imidazole, mIm=methyl-Imidazole, eIm=ethyl-imidazole, bzIm=benzimidazole, bdc=1,4-benzenedicarboxylate. The two last columns report the specific internal pore volume and isotropic cavity size calculated using density functional theory as described above.

Testing method—The activity for ORR of the catalysts was measured in a single fuel cell. For the membrane electrode assembly (MEA), cathode inks were prepared using the following formulation: 20 mg of Fe—N—C catalyst, 652 μl of a 5.0 wt % Nafion@ solution, 326 μl of ethanol and 272 μl of de-ionized water.

The inks were alternatively sonicated and agitated with a vortex mixer every 15 min. The required aliquot of ink was then pipetted on to a 5.0 cm² gas diffusion layer material (SGL Sigracet S10-BC) to result in a Fe—N—C loading of 1.0 mgcm⁻². The cathode was then placed in a vacuum oven at 90° C. to dry for 2 h. The anode was 0.5 mgcm⁻² Pt loading on Sigracet S10-BC gas diffusion layer. MEAs were prepared by hot-pressing 5.0 cm² anode and cathode against either side of a Nafion™ NRE-117 membrane (Chemours Company) at 135° C. for 2 min.

PEMFC tests were performed with a single-cell fuel cell with serpentine flow field (Fuel Cell Technologies Inc.). For the tests, the fuel cell temperature was 80° C., the humidifiers were set at 100° C. (near 100% relative humidity of the incoming gases), and the inlet pressures were set to 1 bar gauge for both anode and cathode sides. The flow rates for humidified H₂ and O₂ were about 50-70 standard cubic centimetres per metre (sccm) downstream of the fuel cell.

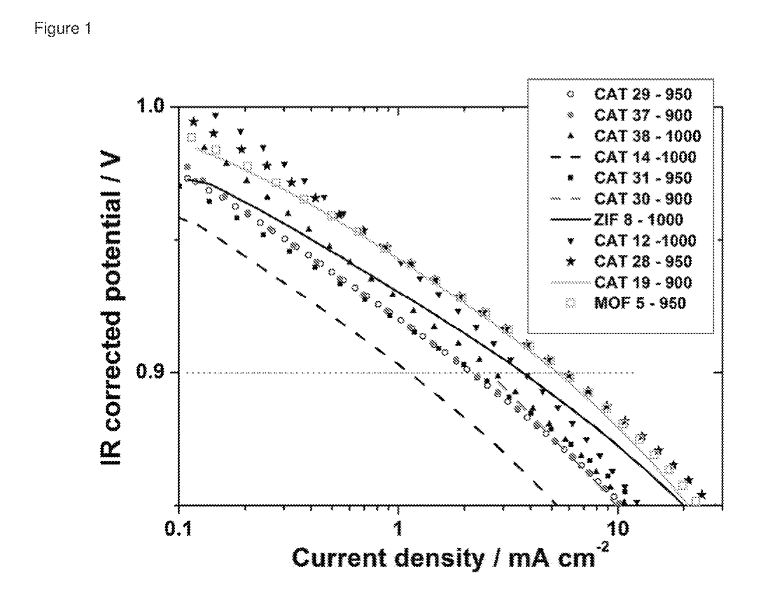

FIG. 1 shows the PEM fuel cell polarization curves recorded for different catalysts, in the high potential region where the performance is controlled by the ORR kinetics. In order to present the results in a concise manner, the current density is read at 0.9 V iR-free potential, then divided by the catalyst loading (1.0 mgcm⁻²).

The scalar Ag⁻¹ at 0.9 V iR-free potential represents the activity of a given catalyst in these fixed experimental conditions of O₂ pressure, relative humidity and temperature. Since all catalysts were synthesized identically except for the pyrolysis temperature, the catalyst label only includes the sample code of the MOF used and the applied pyrolysis temperature in NH₃ (900, 950 or 1000° C.). The three- or four-digit number used in the legend corresponds to the pyrolysis temperature in NH₃, optimized for each MOF structure. The two-digit number following CAT corresponds to the internal code, and the corresponding structure can be found in Table 1. The figure shows a range of activities from about 1.0 to 5.6 Ag⁻¹ at 0.9 V, highlighting the importance of selecting a proper MOF structure in order to obtain the highest optimized ORR activity after pyrolysis. Three MOFs (CAT 28, CAT 19, MOF 5) result in higher ORR activity than that obtained with ZIF-8, the prior state-of-the art.

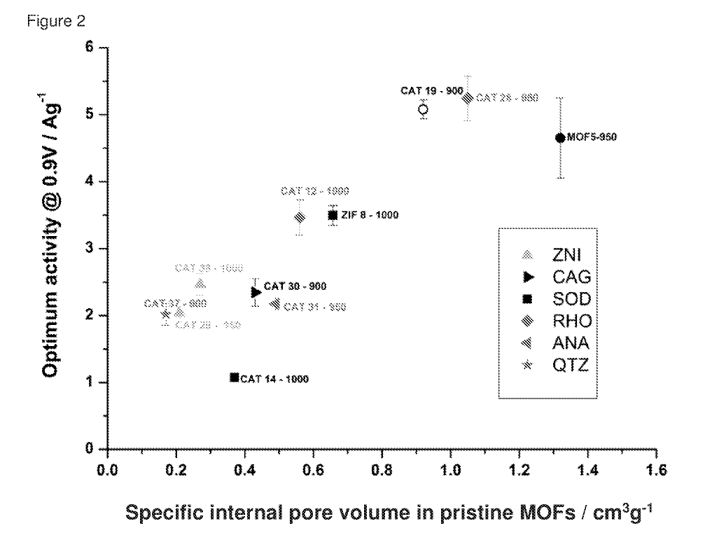

FIG. 2 shows a correlation between the optimum mass activity of the catalyst (as dependent on the optimum pyrolysis temperature) and the specific internal pore volume in the pristine MOF.

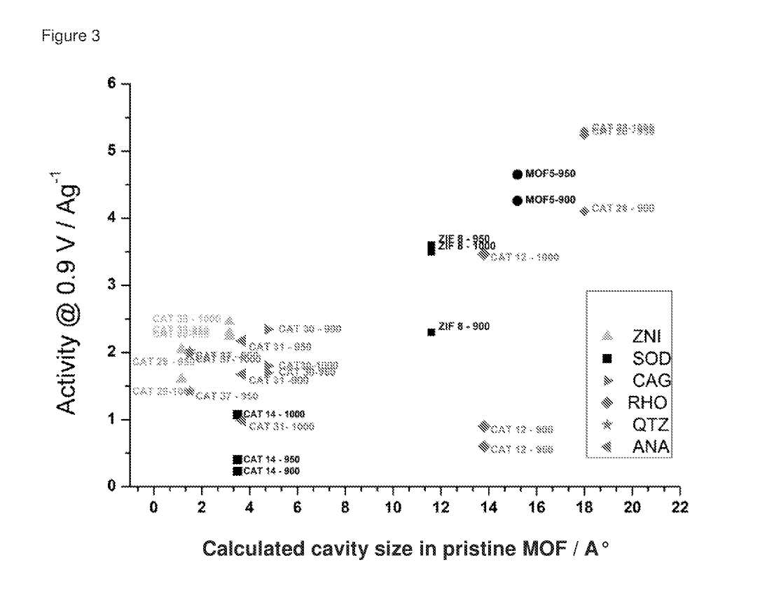

FIG. 3 shows the correlation between the mass activity for ORR of this series of Fe—N—C catalysts and the calculated isotropic cavity size of the MOFs (for those MOFs that have isotropic cavities). For pristine MOF structures showing several cavity sizes (CAT-31, MOF-5), the largest cavity size was selected to produce FIG. 2.

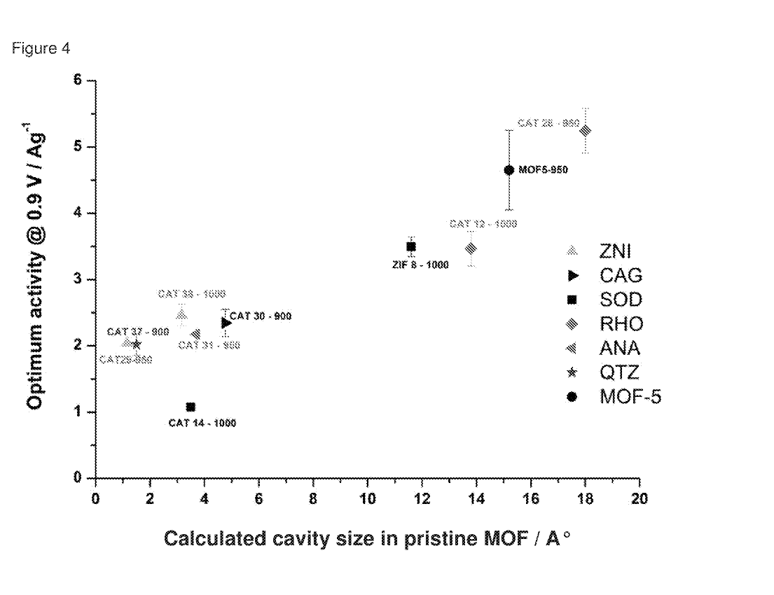

While for a given MOF (fixed x-axis value in FIG. 3), the ORR activity after pyrolysis depends on the pyrolysis temperature, a clear correlation is observed between the ORR activity at the optimum temperature (MOF-dependent) and the calculated isotropic cavity size in the pristine MOF (FIG. 4). A code is applied to indicate the crystalline topologies in those various MOFs (see legend in the figures).

In this first series of examples, the milling rate used to mix Fe(II) acetate, 1,10-phenanthroline and a MOF was 400 rpm. In these conditions, this milling speed was able to amorphise the crystalline MOFs. This effect is particularly emphasized on MOFs with large cavity size that are probably less mechanically robust. There is nevertheless a memory effect of the cavity size in pristine MOFs on the final pyrolyzed products, as clearly demonstrated in FIGS. 2 to 4.

### Worked Examples—Second Series

To better demonstrate the correlation between the cavity size in pristine isotropic MOFs and the ORR activity in pyrolyzed products, the milling speed was reduced to 100 rpm in order to maintain the XRD patterns of the pristine MOFs (and hence their cavity size) after the milling of iron acetate, 1,10-phenanthroline and MOF. Unmodified XRD patterns after 100 rpm milling were observed on all MOFs in those conditions (not shown here). In this second series of examples, the catalyst precursors before pyrolysis are therefore characterized by the cavity size of the pristine MOFs. The synthesis conditions were otherwise identical to those indicated for the first series of examples. For each MOF, the optimum temperature (as shown in FIG. 4) was selected as the pyrolysis temperature.

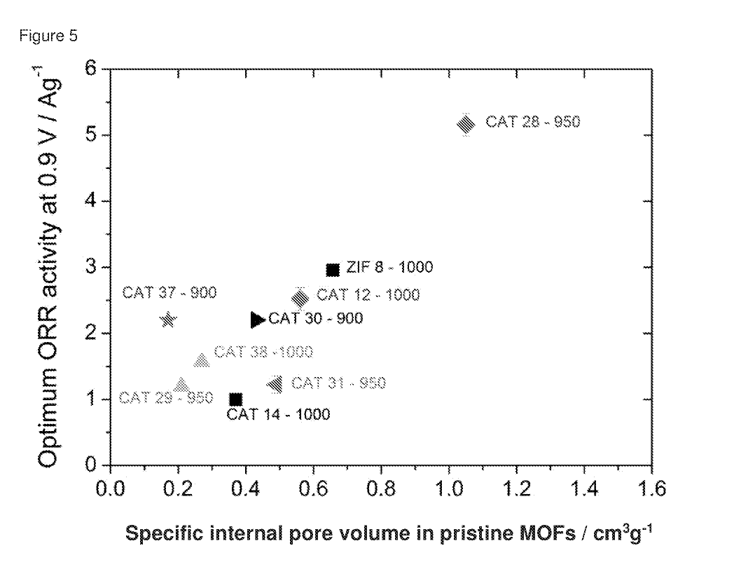

This second series of catalysts demonstrated the ORR activity-specific internal pore volume correlation for catalyst precursors whose XRD patterns show the retained structure of pristine MOFs, even after the milling stage at 100 rpm (FIG. 5).

### Exemplary Synthesis Method 2

The catalyst precursors prepared according to method 1 may be pyrolyzed first in inert gas such as N₂, Ar, etc (ramp heating mode or flash heating mode) at a temperature sufficient to remove, together with volatile products, the first transition metal present in the MOF, and to effect the carbonization of the MOF, then pyrolyzed in an etching gas (NH₃, CO₂, CO, etc) that further increases the porosity of the catalysts and increase the number of Metal-NₓC_{y} sites present on the surface of the catalysts.

### Exemplary Synthesis Method 3 (One-Pot Synthesis)

The catalyst precursors were prepared via a so-called one-pot approach. Typically, weighed amounts of the dry powder of Fe(II)Ac, 1,10-phenanthroline, MOF ligand and ZnO were mixed by grinding or ball-milling. The MOF formation then occurred under solvothermal or mechanical conditions. The catalyst precursors were then pyrolysed in flowing ammonia at the optimum temperature already identified for each MOF in the Exemplary Synthesis Method 1.

### Worked Examples

### Cat-28 (Example of the Invention)

ZnO (3.0047 g, 37 mmol), eIm (7.1495 g, 72 mmol), (NH₄)₂SO₄ (0.7541 g, 7 mmol), Fe(Ac)₂ (0.1188 g, 0.68 mmol) and 1,10-phenanthroline (2.377 g, 13 mmol) were placed in a zirconium mill pot with DMF (6 ml) and zirconia milling balls. The mixture was ground for 30 min in a Fritsch mill at 400 rpm. The light pink solid obtained was dried in air. The product was then pyrolysed in flowing ammonia at 950° C. according to the method disclosed in Exemplary Synthesis Method 1.

### ZIF-8 (Comparative Example)

ZnO (2.2803 g, 28 mmol), mIm (5.0349 g, 61 mmol), Fe(Ac)₂ (0.0679 g,) and 1,10-phenanthroline (1.2092 g, 6.7 mmol) were ground into a homogenous mixture then sealed in solvothermal bomb under Ar. The reaction mixture was heated to 180° C. for 18 hours. Upon cooling a damp red solid was obtained. The product was dried under vacuum at 100° C. for 3 hours and a pink solid product obtained. The product was then pyrolysed in flowing ammonia at 1000° C. according to the method disclosed in Exemplary Synthesis Method 1.

### CAT-38 (Comparative Example)

ZnO (2.2709 g, 28 mmol), Im (4.1942 g, 62 mmol), Fe(Ac)₂ (0.0655 g, 0.35 mmol) and 1,10-phenanthroline (1.2330 g, 6.9 mmol) were ground into a homogenous mixture then sealed in solvothermal bomb under Ar. The reaction mixture was heated to 180° C. for 18 hours and a pink solid product obtained. The product was then pyrolysed in flowing ammonia at 1000° C. according to the method disclosed in Exemplary Synthesis Method 1.

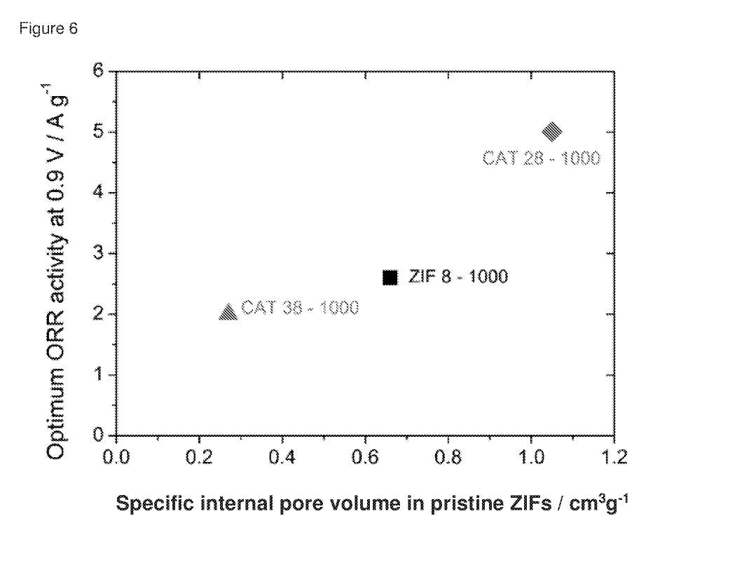

The results are shown in FIG. 6 and it can be seen that the example of the invention shows superior activity to the comparable examples when made by the one-pot method (Exemplary Synthesis Method 3).

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents. It is particularly noted that although the examples were based on Fe—N—C active sites comparable results may be achieved using Co—N—C catalysts.

1. A method for the manufacture of an oxygen reduction reaction (ORR) catalyst, the method comprising:
pyrolysing a metal organic framework (MOF) material having a specific internal pore volume of 0.7 cm³g⁻¹ or greater together with a source of iron and/or cobalt to form the catalyst,
wherein the MOF material comprises nitrogen and/or the MOF material is pyrolysed together with a source of nitrogen and the source of iron and/or cobalt.

2. The method according to claim 1, wherein the MOF material comprises a transition metal selected from Zn, Mg, Cu, Ag, and Ni, or a combination of two or more thereof.

3. The method according to claim 2, wherein the transition metal comprises zinc.

4. The method according to claim 1, wherein the MOF material is a Zeolitic Imidazolate Framework (ZIF) material.

5. The method according to claim 1, wherein the MOF material has a specific internal pore volume of 0.9 cm³g⁻¹ or greater.

6. The method according to claim 1, wherein the source of iron and/or cobalt is a salt of iron and/or cobalt.

7. The method according to claim 1, wherein the pyrolysis of the MOF material is conducted at a temperature from 700 to 1500° C.

8. The method according to claim 1, wherein the source of nitrogen comprises a nitrogen-containing ligand, preferably 1,10-phenanthroline.

9. The method according to claim 1, wherein the pyrolysis is conducted under an atmosphere comprising, argon, nitrogen, ammonia, or hydrogen, or mixtures thereof.

10. The method according to claim 1, wherein the pyrolysis is conducted in two steps, a first step under an inert atmosphere and a second step under an atmosphere comprising ammonia, hydrogen, carbon dioxide and/or carbon monoxide.

11. The method according to claim 1, wherein the MOF material has an average crystal size with a longest size of 200 nm or less.

12. The method according to claim 1, wherein the MOF material is provided on an electrically conducting support.

13. A method for the manufacture of an ORR catalyst, the method comprising:
pyrolysing a metal organic framework (MOF) material having an isotropic cavity shape with a largest cavity size of 12 Å or greater together with a source of iron and/or cobalt to form the catalyst,
wherein the MOF material comprises nitrogen and/or the MOF material is pyrolysed together with a source of nitrogen and the source of iron and/or carbon.

14. A method for the manufacture of an oxygen reduction reaction (ORR) catalyst, the method comprising:
combining a metal organic framework (MOF) ligand and MOF metal source with a source of iron and/or cobalt and optionally a source of nitrogen;
applying a source of energy sufficient to provide a catalyst precursor comprising a MOF material having a specific internal pore volume of 0.7 cm³g⁻¹ or greater;
and pyrolysing the catalyst precursor to provide the ORR catalyst.

15. A method for the manufacture of an oxygen reduction reaction (ORR) catalyst, the method comprising:
combining a metal organic framework (MOF) ligand and MOF metal source with a source of iron and/or cobalt and optionally providing a source of nitrogen;
applying a source of energy sufficient to provide a catalyst precursor comprising a MOF material having an isotropic cavity shape with a largest cavity size of 12 Å or greater;
and pyrolysing the catalyst precursor to provide the ORR catalyst.

16. An ORR catalyst obtainable by the method of claim 1.

17. The method according to claim 1, wherein the method further comprises forming an ink composition comprising the catalyst and a polymer.

18. An ink composition obtainable by the method of claim 17.

19. A cathode electrode for a fuel cell comprising the ORR catalyst of claim 16.

20. An ORR catalyst obtainable by the method of claim 13.

21. An ORR catalyst obtainable by the method of claim 14.

22. An ORR catalyst obtainable by the method of claim 15.

23. The method according to claim 13, wherein the method further comprises forming an ink composition comprising the catalyst and a polymer.

24. The method according to claim 14, wherein the method further comprises forming an ink composition comprising the catalyst and a polymer.

25. The method according to claim 15, wherein the method further comprises forming an ink composition comprising the catalyst and a polymer.

26. An ink composition obtainable by the method of claim 23.

27. An ink composition obtainable by the method of claim 24.

28. An ink composition obtainable by the method of claim 25.

29. A cathode electrode for a fuel cell comprising the ORR catalyst of claim 20.

30. A cathode electrode for a fuel cell comprising the ORR catalyst of claim 21.

31. A cathode electrode for a fuel cell comprising the ORR catalyst of claim 22.
